(19) United States
(12) Patent Application Publication
(10) Pub. No.: US 2012/0030566 A1
(43) Pub. Date: Feb. 2, 2012

(54) SYSTEM WITH TOUCH-BASED SELECTION OF DATA ITEMS

(76) Inventor: B. Michael Victor, Menlo Park, CA (US)

(21) Appl. No.: 12/845,657

(22) Filed: Jul. 28, 2010

(51) Int. Cl. G06F 3/048; G06F 3/01

(52) U.S. Cl. 715/702; 715/835

(57) ABSTRACT

Computing equipment may display data items in a list on a touch screen display. The computing equipment may use the touch screen display to detect touch gestures. A user may select a data item using a touch gesture such as a tap gesture. In response, the computing equipment may display a selectable option. When the option is displayed, movable markers may be placed in the list. The markers can be dragged to new locations to adjust how many of the data items are selected and highlighted in the list. Ranges of selected items may be merged by moving the markers to unify separate groups of selected items. A region that contains multiple selectable options may be displayed adjacent to a selected item. The selectable options may correspond to different ways to select and deselect items. Multifinger swipe gestures may be used to select and deselect data items.

### BACKGROUND

This relates generally to systems for manipulating data items and, more particularly, to systems that assist users in selecting and highlighting one or more items in a list of items using touch commands.

Computer users often use software that manipulates data items. For example, a file browser may be used to display a list of filenames or a grid of thumbnails. The filenames and thumbnails may correspond to text files, image files, music files, or other data items. A user may wish to perform operations on the data items. The user may, for example, want to rename the data items or may want to delete, copy, move, or otherwise manipulate the data items. As another example, a program may present a table of data items. The user may want to move data items to different parts of the table or may want to delete, copy, or otherwise manipulate the entries in the table.

Users can typically select and highlight items of interest using pointer-based commands. For example, a user may select multiple items by holding down an appropriate keyboard key such as a command or control key and clicking on desired items using a mouse or track pad. The items that are selected in this way may be highlighted following each click operation. Once all desired items have been selected, action may be taken on the selected items. For example, the user may delete the selected items or may move the selected items.

Data items may also be selected using an adjustable-size highlight box. A user may adjust the size and location of the highlight box using a mouse or track pad. For example, a user may use a mouse or track pad to perform a click and drag operation in which the highlight box is expanded and contracted until desired data items in a list have been highlighted.

In devices such as cellular telephones with touch screens, a user can select content such as web page content and email text using adjustable highlight boxes. The user can adjust the highlight boxes by dragging the edges of the highlight boxes to desired locations.

Data selection techniques such as these often require cumbersome accessories or awkward selection techniques, particularly in environments such as those associated with touch screen devices. In many situations, desired data items cannot be selected and deselected as desired. It would therefore be desirable to be able to provide improved systems for selecting and manipulating data items.

### SUMMARY

Computing equipment may have a display such as a touch screen display. The touch screen display may be used to display data items in a list. The list may be a one-dimensional list such as a row or column of data items or may be a two-dimensional array of data items containing multiple rows and columns.

A user may select data items on the display using touch commands. For example, a user may select a desired data item by tapping on the data item. Data items that have been selected can be highlighted to provide the user with visual feedback.

A selectable option may be displayed in response to selection of a data item. The selectable option may be, for example, a selectable symbol that is displayed adjacent to the selectable option. If the user selects the selectable symbol using tap gesture or other input, a pair of movable markers may be displayed before and after the selected data item. Drag gestures may be used to move the markers within the list to select more data items or fewer data items as desired. Selected data items may be deselected using taps or other touch gestures.

When a data item is selected, a selectable option region that contains multiple selectable options may be displayed adjacent to the data item. The region may contain options that allow a user to select all items in the list, to deselect one or more items in the list, or to select more items. If a user selects the option that allows the user to select more items, movable markers may be displayed in the list.

Swipe gestures such as two-finger swipe gestures may be used to select ranges of data items. For example, a user may swipe over a number of data items in a list. Each data item that is touched by part of the swipe may be selected and highlighted. A subset of the selected data items may be deselected using a two-finger swipe gesture. When swiping over both selected and unselected data items, all touched data items may be selected. Separate ranges of selected items can be merged into a unified range by swiping across all intervening unselected items.

After selecting data items of interest using touch gestures such as these, actions may be taken on the selected data items. For example, items may be deleted, moved, copied, cut, renamed, compressed, attached to an email, or otherwise processed using application and operating system code.

Further features of the invention, its nature and various advantages will be more apparent from the accompanying drawings and the following detailed description of the preferred embodiments.

### BRIEF DESCRIPTION OF THE DRAWINGS

FIG. 1 is schematic diagram of an illustrative system in which displayed data items may be selected using touch gestures in accordance with an embodiment of the present invention.

FIG. 2 is a schematic diagram of illustrative computing equipment that may be used in a system of the type shown in FIG. 1 in accordance with an embodiment of the present invention.

FIG. 3 is a cross-sectional side view of equipment that includes a touch sensor and display structures in accordance with an embodiment of the present invention.

FIG. 4 is a schematic diagram showing code that may be stored and executed on computing equipment such as the computing equipment of FIG. 1 in accordance with an embodiment of the present invention.

FIG. 5 is a schematic diagram showing how touch gesture data may be extracted from touch event data using touch recognition engines in accordance with an embodiment of the present invention.

FIG. 6A is a diagram of an illustrative double tap gesture in accordance with an embodiment of the present invention.

FIG. 6B is a diagram of an illustrative touch and hold (touch contact) gesture in accordance with an embodiment of the present invention.

FIG. 6C is a diagram of an illustrative two-finger swipe gesture in accordance with an embodiment of the present invention.

FIG. 6D is a diagram of an illustrative drag touch gesture in accordance with an embodiment of the present invention.

FIG. 7 shows a screen of data items in which a user has made a touch gesture by contacting one of the data items to select that data item in accordance with an embodiment of the present invention.

FIG. 8 shows how the data item that was touched in the screen of FIG. 7 may be selected and showing how a selectable option may be displayed adjacent to the selected data item in accordance with an embodiment of the present invention.

FIG. 9 shows how moveable markers may be displayed adjacent to the selected data item in response to user selection of the selectable option of FIG. 8 in accordance with the present invention.

FIG. 10 shows how the markers of FIG. 9 may be repositioned on the screen and how associated data items in the list of displayed items may be selected in response to user touch gestures such as drag gestures in accordance with an embodiment of the present invention.

FIG. 11 shows how some of the selected data items of FIG. 10 may be deselected in response to a touch gesture in accordance with an embodiment of the present invention.

FIG. 12 shows how data items may be displayed in a two-dimensional array and shows how a user may select one of the data items using a touch command in accordance with an embodiment of the present invention.

FIG. 13 shows how a selectable option may be displayed adjacent to a selected data item of FIG. 12 in accordance with an embodiment of the present invention.

FIG. 14 shows a screen in which movable markers have been displayed adjacent to the selected data item in response to user selection of the selectable option of FIG. 13 in accordance with an embodiment of the present invention.

FIG. 15 shows a screen of data items that has been updated in response to user movement of one of the markers of FIG. 14 using a drag touch command in accordance with an embodiment of the present invention.

FIG. 16 shows a screen in which a user is moving a selectable marker using a drag command so as to merge two groups of selected data items in accordance with an embodiment of the present invention.

FIG. 17 shows a screen in which the two groups of selected data items of FIG. 16 have been merged in accordance with an embodiment of the present invention.

FIG. 18 is a flow chart of illustrative steps involved in allowing a user to select and manipulate displayed data items using touch gestures in accordance with an embodiment of the present invention.

FIG. 19 shows a screen of data items and shows how a touch gesture such as a tap or hold gesture may be used to select one of the data items in accordance with an embodiment of the present invention.

FIG. 20 shows a screen in which a region of options for selecting data items has been displayed in response to detecting the gesture of FIG. 19 in accordance with an embodiment of the present invention.

FIG. 21 shows a screen in which all data items have been selected in response to selection of a select all option from among the displayed options in FIG. 20 in accordance with an embodiment of the present invention.

FIG. 22 shows a screen in which a selected data item and associated movable markers have been displayed in response to selection of a select more option from among the displayed options in FIG. 20 in accordance with an embodiment of the present invention.

FIG. 23 is a flow chart of illustrative steps involved in selecting and manipulating data times using an arrangement of the type shown in FIG. 20 in which selection options are displayed for a user in accordance with an embodiment of the present invention.

FIG. 24 shows a screen in which a gesture such as a two-finger touch is being used to select a data item from a list of data items in accordance with an embodiment of the present invention.

FIG. 25 shows a screen in which a gesture such as a multifinger swipe gesture is being used to select multiple items from a list of displayed data items in accordance with an embodiment of the present invention.

FIG. 26 shows a screen in which selected data items are being deselected using a gesture such as a multifinger swipe gesture in accordance with an embodiment of the present invention.

FIG. 27 shows a screen in which a gesture such as a multifinger swipe gesture is being used to select a group of data items including both previously selected and previously deselected data items in accordance with an embodiment of the present invention.

FIG. 28 is a flow chart of illustrative steps involved in selecting and manipulating data items using touch gestures in accordance with an embodiment of the present invention.

### DETAILED DESCRIPTION

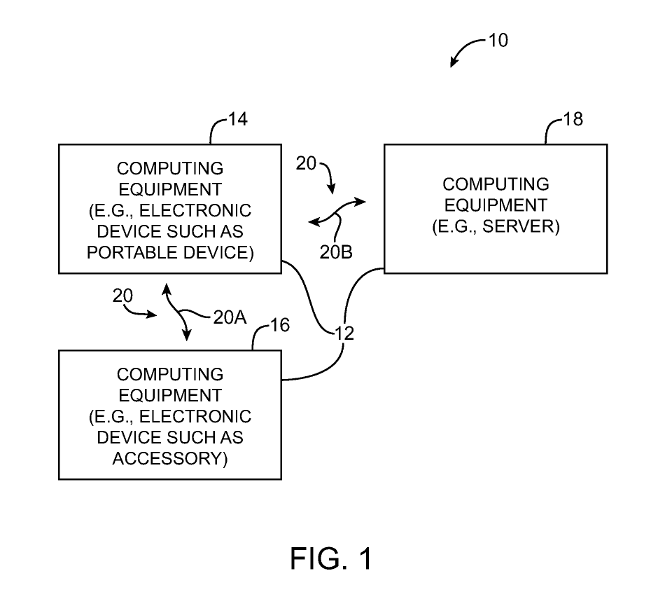

An illustrative system of the type that may be used to select and manipulate data items using touch gestures is shown in FIG. 1. As shown in FIG. 1, system 10 may include computing equipment 12. Computing equipment 12 may include one or more pieces of electronic equipment such as equipment 14, 16, and 18. Equipment 14, 16, and 18 may be linked using one or more communications paths 20.

Computing equipment 12 may include one or more electronic devices such as desktop computers, servers, mainframes, workstations, network attached storage units, laptop computers, tablet computers, cellular telephones, media players, other handheld and portable electronic devices, smaller devices such as wrist-watch devices, pendant devices, headphone and earpiece devices, other wearable and miniature devices, accessories such as mice, touch pads, or mice with integrated touch pads, joysticks, touch-sensitive monitors, or other electronic equipment.

Software may run on one or more pieces of computing equipment 12. In some situations, most or all of the software may run on a single platform (e.g., a tablet computer with a touch screen or a computer with a touch pad, mouse, or other user input interface). In other situations, some of the software runs locally (e.g., as a client implemented on a laptop), whereas other software runs remotely (e.g., using a server implemented on a remote computer or group of computers). When accessories such as accessory touch pads are used in system 10, some equipment 12 may be used to gather touch input or other user input, other equipment 12 may be used to run a local portion of a program, and yet other equipment 12 may be used to run a remote portion of a program. Other configurations such as configurations involving four or more different pieces of computing equipment 14 may be used if desired.

With one illustrative scenario, computing equipment 14 of system 10 may be based on an electronic device such as a computer (e.g., a desktop computer, a laptop computer or other portable computer, a handheld device such as a cellular telephone with computing capabilities, etc.). In this type of scenario, computing equipment 16 may be, for example, an optional electronic device such as a pointing device or other user input accessory (e.g., a touch pad, a touch screen monitor, a wireless mouse, a wired mouse, a trackball, etc.). Computing equipment 14 (e.g., an electronic device) and computing equipment 16 (e.g., an accessory) may communicate over communications path 20A. Path 20A may be a wired path (e.g., a Universal Serial Bus path or FireWire path) or a wireless path (e.g., a local area network path such as an IEEE 802.11 path or a Bluetooth® path). Computing equipment 14 may interact with computing equipment 18 over communications path 20B. Path 20B may include local wired paths (e.g., Ethernet paths), wired paths that pass through local area networks and wide area networks such as the internet, and wireless paths such as cellular telephone paths and wireless local area network paths (as an example). Computing equipment 18 may be a remote server or a peer device (i.e., a device similar or identical to computing equipment 14). Servers may be implemented using one or more computers and may be implemented using geographically distributed or localized resources.

In an arrangement of the type in which equipment 16 is a user input accessory such as an accessory that includes a touch sensor array, equipment 14 is a device such as a tablet computer, cellular telephone, or a desktop or laptop computer with a touch sensitive screen, and equipment 18 is a server, user input commands may be received using equipment 16 and equipment 14. For example, a user may supply a touch-based gesture to a touch pad or touch screen associated with accessory 16 or may supply a touch gesture to a touch pad or touch screen associated with equipment 14. Gesture recognition functions may be implemented on equipment 16 (e.g., using processing circuitry in equipment 16), on equipment 14 (e.g., using processing circuitry in equipment 14), and/or in equipment 18 (e.g., using processing circuitry in equipment 18). Software for handling operations associated with using touch gestures and other user input to select data items such as clickable files (i.e., files that can be launched by double clicking or double tapping on an associated filename, thumbnail, icon, or other clickable on-screen item) may be implemented using equipment 14 and/or equipment 18 (as an example).

Subsets of equipment 12 may also be used to handle user input processing (e.g., touch data processing) and other functions. For example, equipment 18 and communications link 20B need not be used. When equipment 18 and path 20B are not used, input processing and other functions may be handled using equipment 14. User input processing may be handled exclusively by equipment 14 (e.g., using an integrated touch pad or touch screen in equipment 14) or may be handled using accessory 16 (e.g., using a touch sensitive accessory to gather touch data from a touch sensor array). If desired, additional computing equipment (e.g., storage for a database or a supplemental processor) may communicate with computing equipment 12 of FIG. 1 using communications links 20 (e.g., wired or wireless links).

Computing equipment 12 may include storage and processing circuitry. The storage of computing equipment 12 may be used to store software code such as instructions for software that handles tasks associated with monitoring and interpreting touch data and other user input. The storage of computing equipment 12 may also be used to store software code such as instructions for software that handles data and application management functions (e.g., functions associated with opening and closing files, maintaining information on the data within various files, maintaining lists of applications, launching applications, displaying data items on a display, selecting and highlighting data items in response to user gestures and other user input, deselecting data items, performing actions on selected data items, transferring data between applications, etc). Content such as text, images, and other media (e.g., audio and video with or without accompanying audio) may be stored in equipment 12 and may be presented to a user using output devices in equipment 12 (e.g., on a display and/or through speakers). The processing capabilities of system 10 may be used to gather and process user input such as touch gestures and other user input. These processing capabilities may also be used in determining how to display information for a user on a display, how to print information on a printer in system 10, etc. Other functions such as functions associated with maintaining lists of programs that can be launched by a user and functions associated with caching data that is being transferred between applications may also be supported by the storage and processing circuitry of equipment 12.

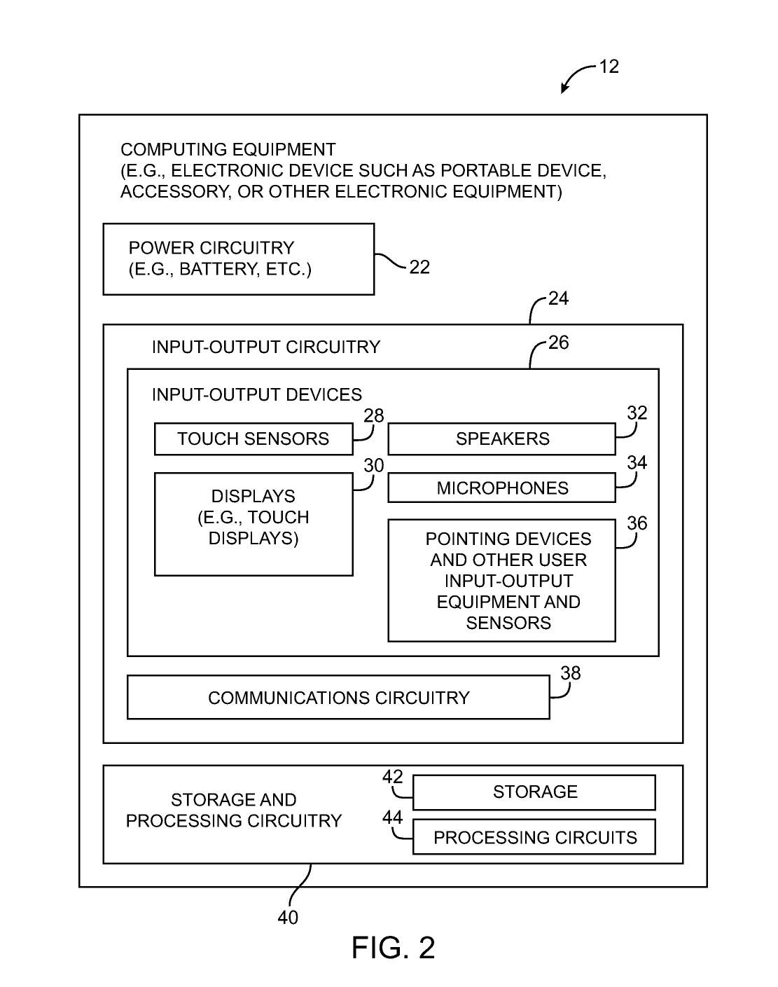

Illustrative computing equipment of the type that may be used for some or all of equipment 14, 16, and 18 of FIG. 1 is shown in FIG. 2. As shown in FIG. 2, computing equipment 12 may include power circuitry 22. Power circuitry 22 may include a battery (e.g., for battery powered devices such a cellular telephones, tablet computers, laptop computers, and other portable devices). Power circuitry 22 may also include power management circuitry that regulates the distribution of power from the battery or other power source. The power management circuit may be used to implement functions such as sleep-wake functions, voltage regulation functions, etc.

Input-output circuitry 24 may be used by equipment 12 to transmit and receive data. For example, in configurations in which the components of FIG. 2 are being used to implement equipment 14 of FIG. 1, input-output circuitry 24 may receive data from equipment 16 over path 20A and may supply data from input-output circuitry 24 to equipment 18 over path 20B.

Input-output circuitry 24 may include input-output devices 26. Devices 26 may include, for example, a display such as display 30. Display 30 may be a touch screen (touch sensor display) that incorporates an array of touch sensors. Display 30 may include image pixels formed from light-emitting diodes (LEDs), organic LEDs (OLEDs), plasma cells, electronic ink elements, liquid crystal display (LCD) components, or other suitable image pixel structures. A cover layer such as a layer of cover glass member may cover the surface of display 30. Display 30 may be mounted in the same housing as other device components or may be mounted in an external housing.

If desired, input-output circuitry 24 may include touch sensors 28. Touch sensors 28 may be included in a display (i.e., touch sensors 28 may serve as a part of touch sensitive display 30 of FIG. 2) or may be provided using a separate touch sensitive structure such as a touch pad (e.g., a planar touch pad or a touch pad surface that is integrated on a planar or curved portion of a mouse or other electronic device).

Touch sensor 28 and the touch sensor in display 30 may be implemented using arrays of touch sensors (i.e., a two-dimensional array of individual touch sensor elements combined to provide a two-dimensional touch event sensing capability). Touch sensor circuitry in input-output circuitry 24 (e.g., touch sensor arrays in touch sensors 28 and/or touch screen displays 30) may be implemented using capacitive touch sensors or touch sensors formed using other touch technologies (e.g., resistive touch sensors, acoustic touch sensors, optical touch sensors, piezoelectric touch sensors or other force sensors, or other types of touch sensors). Touch sensors that are based on capacitive touch sensors are sometimes described herein as an example. This is, however, merely illustrative. Equipment 12 may include any suitable touch sensors.

Input-output devices 26 may use touch sensors to gather touch data from a user. A user may supply touch data to equipment 12 by placing a finger or other suitable object (i.e., a stylus) in the vicinity of the touch sensors. With some touch technologies, actual contact or pressure on the outermost surface of the touch sensor device is required. In capacitive touch sensor arrangements, actual physical pressure on the touch sensor surface need not always be provided, because capacitance changes can be detected at a distance (e.g., through air). Regardless of whether or not physical contact is made between the user's finger or other eternal object and the outer surface of the touch screen, touch pad, or other touch sensitive component, user input that is detected using a touch sensor array is generally referred to as touch input, touch data, touch sensor contact data, etc.

Input-output devices 26 may include components such as speakers 32, microphones 34, switches, pointing devices, sensors, cameras, and other input-output equipment 36. Speakers 32 may produce audible output for a user. Microphones 34 may be used to receive voice commands from a user. Cameras in equipment 36 can gather visual input (e.g., for facial recognition, hand gestures, etc.). Equipment 36 may also include mice, trackballs, keyboards, keypads, buttons, and other pointing devices and data entry devices. Equipment 36 may include output devices such as status indicator light-emitting diodes, buzzers, etc. Sensors in equipment 36 may include proximity sensors, ambient light sensors, thermal sensors, accelerometers, gyroscopes, magnetic sensors, infrared sensors, etc. If desired, input-output devices 26 may include other user interface devices, data port devices, audio jacks and other audio port components, digital data port devices, etc.

Communications circuitry 38 may include wired and wireless communications circuitry that is used to support communications over communications paths such as communications paths 20 of FIG. 1. Communications circuitry 38 may, include wireless communications circuitry that forms remote and local wireless links. Communications circuitry 38 may handle any suitable wireless communications bands of interest. For example, communications circuitry 38 may handle wireless local area network bands such as the IEEE 802.11 bands at 2.4 GHz and 5 GHz, the Bluetooth band at 2.4 GHz, cellular telephone bands, 60 GHz signals, radio and television signals, satellite positioning system signals such as Global Positioning System (GPS) signals, etc.

Computing equipment 12 may include storage and processing circuitry 40. Storage and processing circuitry 40 may include storage 42. Storage 42 may include hard disk drive storage, nonvolatile memory (e.g., flash memory or other electrically-programmable-read-only memory configured to form a solid state drive), volatile memory (e.g., static or dynamic random-access-memory), etc. Processing circuitry 44 in storage and processing circuitry 40 may be used to control the operation of equipment 12. This processing circuitry may be based on one or more microprocessors, microcontrollers, digital signal processors, application specific integrated circuits, etc.

The resources associated with the components of computing equipment 12 in FIG. 2 need not be mutually exclusive. Some of the processing circuitry in storage and processing circuitry 40 may, for example, reside in touch sensor processors associated with touch sensors 28 (including portions of touch sensors that are associated with touch sensor displays such as touch displays 30) and in other chips such as communications integrated circuits, power management integrated circuits, audio integrated circuits, etc. As another example, storage may be implemented both as stand-alone memory chips and as registers and other parts of processors and application specific integrated circuits. There may be, for example, memory and processing circuitry 40 that is associated with communications circuitry 38.

Storage and processing circuitry 40 may be used to run software on equipment 12 such as touch sensor processing code, productivity applications such as spreadsheet applications, word processing applications, presentation applications, and database applications, software for internet browsing applications, voice-over-internet-protocol (VOIP) telephone call applications, email applications, media playback applications, operating system functions such as file browser functions, code that displays one-dimensional and two-dimensional lists (arrays) of data items, etc. Storage and processing circuitry 40 may also be used to run applications such as video editing applications, music creation applications (i.e., music production software that allows users to capture audio tracks, record tracks of virtual instruments, etc.), photographic image editing software, graphics animation software, etc. To support interactions with external equipment (e.g., using communications paths 20), storage and processing circuitry 40 may be used in implementing communications protocols. Communications protocols that may be implemented using storage and processing circuitry 40 include internet protocols, wireless local area network protocols (e.g., IEEE 802.11 protocols—sometimes referred to as WiFi®), protocols for other short-range wireless communications links such as the Bluetooth® protocol, cellular telephone protocols, etc.

A user of computing equipment 14 may interact with computing equipment 14 using any suitable user input interface. For example, a user may supply user input commands using a pointing device such as a mouse or trackball (e.g., to move a cursor and to enter right and left button presses) and may receive output through a display, speakers, and printer (as an example). A user may also supply input using touch commands. Touch-based commands, which are sometimes referred to herein as gestures, may be made using a touch sensor array (see, e.g., touch sensors 28 and touch screens 30 in the example of FIG. 2). Touch gestures may be used as the exclusive mode of user input for equipment 12 (e.g., in a device whose only user input interface is a touch screen) or may be used in conjunction with supplemental user input devices (e.g., in a device that contains buttons or a keyboard in addition to a touch sensor array).

Touch commands (gestures) may be gathered using a single touch element (e.g., a touch sensitive button), a one-dimensional touch sensor array (e.g., a row of adjacent touch sensitive buttons), or a two-dimensional array of touch sensitive elements (e.g., a two-dimensional array of capacitive touch sensor electrodes or other touch sensor pads). Two-dimensional touch sensor arrays allow for gestures such as swipes and flicks that have particular directions in two dimensions (e.g., right, left, up, down). Touch sensors may, if desired, be provided with multitouch capabilities, so that more than one simultaneous contact with the touch sensor can be detected and processed. With multitouch capable touch sensors, additional gestures may be recognized such as multifinger swipes, multifinger taps, pinch commands, etc.

Touch sensors such as two-dimensional sensors are sometimes described herein as an example. This is, however, merely illustrative. Computing equipment 12 may use other types of touch technology to receive user input if desired.

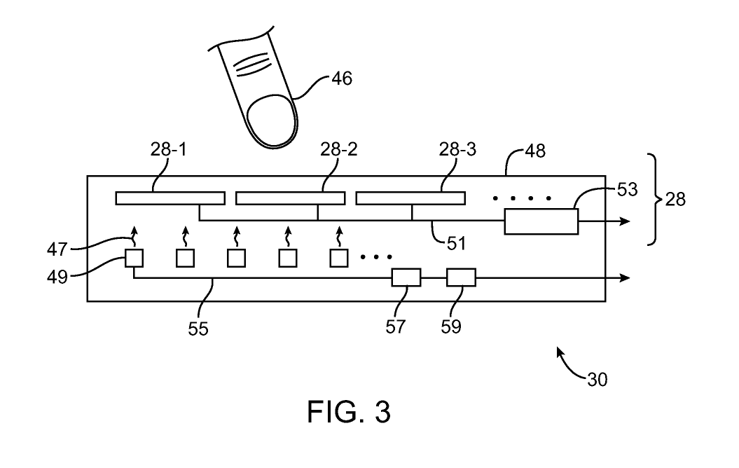

A cross-sectional side view of a touch sensor that is receiving user input is shown in FIG. 3. As shown in the example of FIG. 3, touch sensor 28 may have an array of touch sensor elements such as elements 28-1, 28-2, and 28-3 (e.g., a two-dimensional array of elements in rows and columns across the surface of a touch pad or touch screen). A user may place an external object such as finger 46 in close proximity of surface 48 of sensor 28 (e.g., within a couple of millimeters or less, within a millimeter or less, in direct contact with surface 48, etc.). When touching sensor 28 in this way, the sensor elements that are nearest to object 46 can detect the presence of object 46. For example, if sensor elements 28-1, 28-2, 28-3, . . . are capacitive sensor electrodes, a change in capacitance can be measured on the electrode or electrodes in the immediate vicinity of the location on surface 48 that has been touched by external object 46. In some situations, the pitch of the sensor elements (e.g., the capacitor electrodes) is sufficiently fine that more than one electrode registers a touch signal. When multiple signals are received, touch sensor processing circuitry (e.g., processing circuitry in storage and processing circuitry 40 of FIG. 2) can perform interpolation operations in two dimensions to determine a single point of contact between the external object and the sensor.

Touch sensor electrodes (e.g., electrodes for implementing elements 28-1, 28-2, 28-3 . . . ) may be formed from transparent conductors such as conductors made of indium tin oxide or other conductive materials. Touch sensor circuitry 53 (e.g., part of storage and processing circuitry 40 of FIG. 2) may be coupled to sensor electrodes using paths 51 and may be used in processing touch signals from the touch sensor elements. An array (e.g., a two-dimensional array) of image display pixels such as pixels 49 may be used to emit images for a user (see, e.g., individual light rays 47 in FIG. 3). Display memory 59 may be provided with image data from an application, operating system, or other code on computing equipment 12. Display drivers 57 (e.g., one or more image pixel display integrated circuits) may display the image data stored in memory 59 by driving image pixel array 49 over paths 55. Display driver circuitry 57 and display storage 59 may be considered to form part of a display (e.g., display 30) and/or part of storage and processing circuitry 40 (FIG. 2). A touch screen display (e.g., display 30 of FIG. 3) may use touch sensor array 28 to gather user touch input and may use display structures such as image pixels 49, display driver circuitry 57, and display storage 59 to display output for a user. In touch pads, display pixels may be omitted from the touch sensor and one or more buttons may be provided to gather supplemental user input.

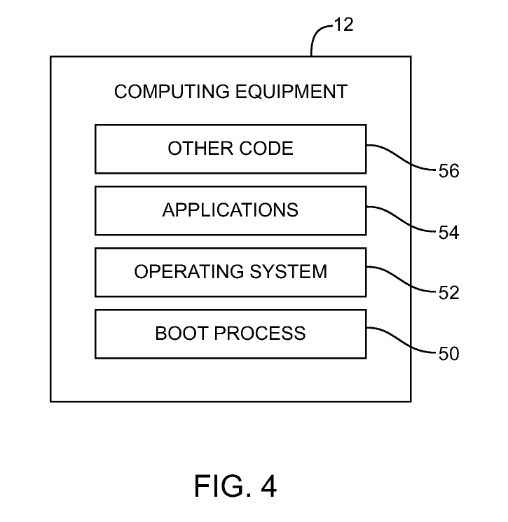

FIG. 4 is a diagram of computing equipment 12 of FIG. 1 showing code that may be implemented on computing equipment 12. The code on computing equipment 12 may include firmware, application software, operating system instructions (e.g., instructions for implementing file browser functions and other functions that display lists of data items), code that is localized on a single piece of equipment, code that operates over a distributed group of computers or is otherwise executed on different collections of storage and processing circuits, etc. In a typical arrangement of the type shown in FIG. 4, some of the code on computing equipment 12 includes boot process code 50. Boot code 50 may be used during boot operations (e.g., when equipment 12 is booting up from a powered-down state). Operating system code 52 may be used to perform functions such as creating an interface between computing equipment 12 and peripherals, supporting interactions between components within computing equipment 12, monitoring computer performance, executing maintenance operations, providing libraries of drivers and other collections of functions that may be used by operating system components and application software during operation of computing equipment 12, supporting file browser functions and other functions that display lists of data items, running diagnostic and security components, etc.

Applications 54 may include productivity applications such as word processing applications, email applications, presentation applications, spreadsheet applications, and database applications. Applications 54 may also include communications applications, media creation applications, media playback applications, games, web browsing application, etc. Some of these applications may run as stand-alone programs, others may be provided as part of a suite of interconnected programs. Applications 54 may also be implemented using a client-server architecture or other distributed computing architecture (e.g., a parallel processing architecture). Applications 54 may include software that displays lists of data items (e.g., lists of pictures, documents, and other data files, entries in tables and other data structures, etc.). Examples of applications include address books, business contact manager applications, calculator applications, dictionaries, thesauruses, encyclopedias, translation applications, sports score trackers, travel applications such as flight trackers, search engines, calendar applications, media player applications, movie ticket applications, people locator applications, ski report applications, note gathering applications, stock price tickers, games, unit converters, weather applications, web clip applications, clipboard applications, clocks, etc. Code for programs such as these may be provided using applications or using parts of an operating system or other code of the type shown in FIG. 4, including additional code 56 (e.g., add-on processes that are called by applications 54 or operating system 52, plug-ins for a web browser or other application, etc.).

Code such as code 50, 52, 54, and 56 may be used to handle user input commands (e.g., gestures and non-gesture input) and can perform corresponding actions. For example, the code of FIG. 4 may be configured to receive touch input. In response to the touch input, the code of FIG. 4 may be configured to perform processing functions and output functions. Processing functions may include evaluating mathematical functions, moving data items within a group of items, adding and deleting data items, updating databases to reflect which data items have been selected and/or modified, presenting data items to a user on a display, printer, or other output device, highlighting selected data items on a display, sending emails or other messages containing output from a process, etc.

Raw touch input (e.g., signals such as capacitance change signals measured using a capacitive touch sensor or other such touch sensor array data) may be processed using storage and processing circuitry 40 (e.g., using a touch sensor chip that is associated with a touch pad or touch screen, using a combination of dedicated touch processing chips and general purpose processors, using local and remote processors, or using other storage and processing circuitry).

Gestures such as taps, holds, swipes, drags, flicks, multitouch commands, and other touch input may be recognized and converted into gesture data by processing raw touch data. As an example, a set of individual touch contact points that are detected within a given radius on a touch screen and that occur within a given time period may be recognized as a tap gesture (sometimes referred to as a touch gesture, touch contact, or contact gesture). A smooth lateral movement may form a swipe gesture (e.g., a gesture that moves an on-screen slider or that imparts motion to displayed content). Drag gestures may be used to move displayed items such as markers. A user may, for example, select a marker by touching the marker (e.g., with a finger or other external object) and may move the marker to a desired location by dragging the marker to that location. With a typical drag gesture of this type, the user's finger is not removed until the marker (or other item being moved) has reached its desired destination.

Gesture data may be represented using different (e.g., more efficient) data structures than raw touch data. For example, ten points of localized raw contact data may be converted into a single tap or hold gesture. Code 50, 52, 54, and 56 of FIG. 4 may use raw touch data, processed touch data, recognized gestures, other user input, or combinations of these types of input as input commands during operation of computing equipment 12.

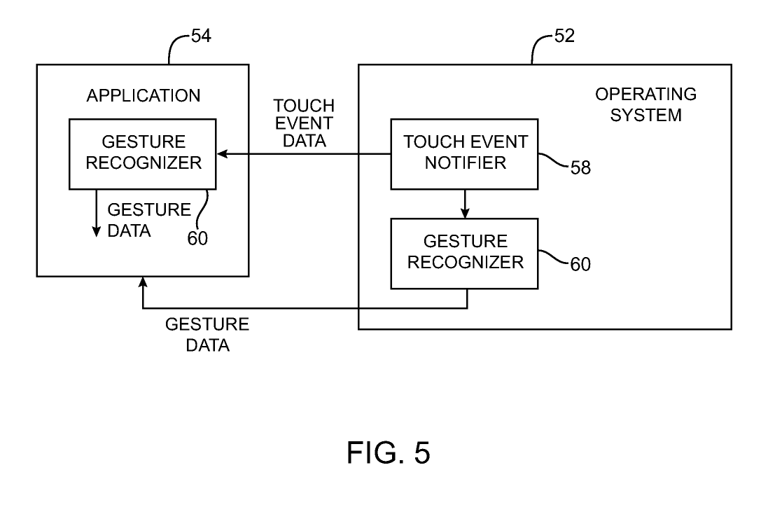

If desired, touch data (e.g., raw touch data) may be gathered using a software component such as touch event notifier 58 of FIG. 5. Touch event notifier 58 may be implemented as part of operating system 52 or as other code executed on computing equipment 12. Touch event notifier 58 may provide touch event data (e.g., information on contact locations with respect to orthogonal X and Y dimensions and optional contact time information) to gesture recognition code such as one or more gesture recognizers 60. Operating system 52 may include a gesture recognizer that processes touch event data from touch event notifier 58 and that provides corresponding gesture data as an output. An application such as application 54 or other software on computing equipment 12 may also include a gesture recognizer. As shown in FIG. 5, for example, application 54 may perform gesture recognition using gesture recognizer 60 to produce corresponding gesture data.

Gesture data that is generated by gesture recognizer 60 in application 54 or gesture recognizer 60 in operating system 52 or gesture data that is produced using other gesture recognition resources in computing equipment 12 may be used in controlling the operation of application 54, operating system 52, and other code (see, e.g., the code of FIG. 4). For example, gesture recognizer code 60 may be used in detecting gesture activity from a user to select or deselect some or all of the content that is being displayed on a display in computing equipment 12 (e.g., display 30), may be used in detecting gestures to delete, copy, move, or otherwise manipulate selected content, or may be used to initiate other desired actions. Non-touch input may be used in conjunction with touch activity. For example, items can be selected by using touch gestures such as tap and swipe gestures in conjunction with button press activity (e.g., a click of a mouse or track pad button or a press of a keyboard key). User button press activity may be combined with other gestures (e.g., a two-finger or three-finger swipe or a tap) to form more complex user commands.

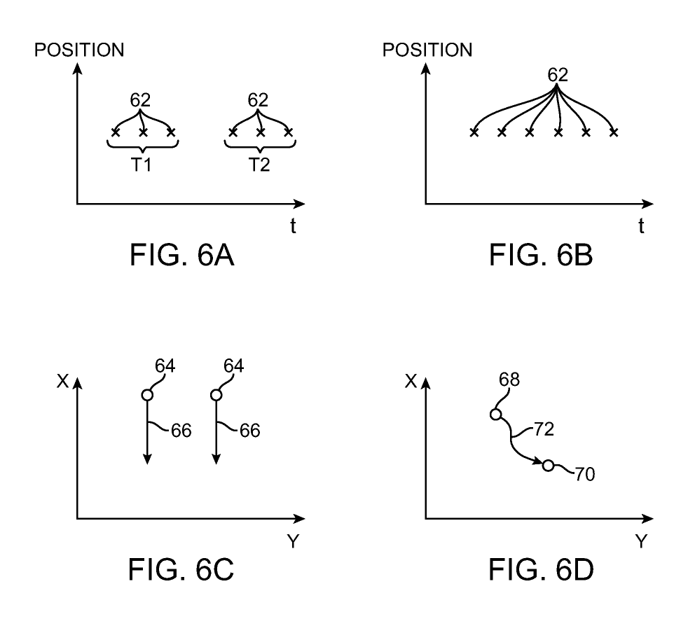

FIGS. 6A, 6B, 6C, and 6D are graphs of illustrative touch sensor data that may be associated with touch gestures that are supplied to computing equipment 12 by a user.

As shown in FIG. 6A, a user may make a double-tap gesture by touching a touch sensor twice. In the graph of FIG. 6A, position information is plotted in one dimension (position) as a function of time. In a typical touch screen display, touch data is gathered in two dimensions (i.e., X and Y). As shown in FIG. 6A, a double-tap gesture may involve two repeated contacts with the touch sensor at the same (or nearly the same) location on the sensor. In particular, the double-tap gesture may include first tap T1 and second tap T2. Taps T1 and T2 may each produce multiple raw touch sensor readings 62. Computing equipment 12 may process raw touch data 62 to detect taps T1 and T2 (and the double-tap formed by T1 and T2). Double-tap gestures may be performed with one finger, two fingers, three fingers, or more than three fingers. Triple tap gestures and gestures with more than three touch events may also be recognized by computing equipment 12.

In some situations, a user may make a more prolonged contact with a particular location on the touch sensor. This type of touch gesture may sometimes be referred to as a hold gesture. A graph showing how the position of the user's finger may remain relatively constant during a hold gesture is shown in FIG. 6B. As shown in FIG. 6B, touch data 62 in a hold gesture may be fairly constant in position as a function of time.

FIG. 6C illustrates a two-finger swipe (drag) gesture. Initially, a user may use two fingers (or other external objects) to touch the touch sensor at touch points 64. These two fingers may then be moved along the touch sensor in parallel, as indicated by swipe paths 66. Swipes may include one finger, two fingers, three fingers, or more than three fingers. Rapid swipes may be interpreted as flicks. Swipe-like gestures that are used to position displayed elements are sometimes referred to as drag gestures. When the finger that forms a drag gesture is released when a moved element is located on top of a folder icon, application icon, or other on-screen destination, the drag gesture may sometimes be referred to as a drag and drop gesture. FIG. 6D illustrates a typical drag gesture. Initially, a user may contact the touch sensor at point 68 (e.g., to select a marker or other on-screen element). After touching the screen at point 68 to select the marker, the user may drag the marker across the screen (e.g., following path 72). At a desired destination location such as location 70, the user may release the finger to complete the drag gesture. Drag gestures are sometimes referred to as swipes.

More than one touch point may be used when performing a drag operation (i.e., to form a multifinger drag gesture such as a two-finger drag gesture or a three-finger drag gesture).

Touch gestures may be used in selecting and deselecting displayed data items. Data items may be displayed in a list. The data items may include files such as documents, images, media files such as audio files and video files, entries in a table or other data structure, or any other suitable content. Data items may be displayed in the form of discrete and preferably individualized regions on a display. For example, data items may be displayed using text (e.g., clickable file name labels or table entry text data), graphics (e.g., an icon having a particular shape or accompanying label), thumbnails (e.g., a clickable rectangular region on a display that contains a miniaturized or simplified version of the content of the file that is represented by the thumbnail), symbols, or using other suitable visual representation schemes. The list in which the data items are displayed may be one-dimensional (e.g., a single column or row of data items) or two dimensional (e.g., a two-dimensional array of data items). One-dimensional lists may be used to display table content, files in a operating system file browser, files in an application-based content browser, files displayed in other operating system or application contexts, or other situations in which a one-dimensional list is desired. Two-dimensional lists may be used to display two-dimensional table content (e.g., tables containing rows and columns of table entries), two dimensional arrays of images, text files, and other data items in an operating system or application file browser, two-dimensional arrays of data items used in other operating system and application contexts, etc.

By using touch gestures, a user can select data items of interest. The data items that the user selects can be highlighted to provide the user with visual feedback. Content may be highlighted by changing the color of the highlighted content relative to other content, by changing the saturation of the selected content, by encircling the content using an outline, by using animated effects, by increasing or decreasing screen brightness in the vicinity of the selected content, by enlarging the size of selected content relative to other content, by placing selected content in a pop-up window or other highlight region on a screen, by using other highlighting arrangement, or by using combinations of such arrangements. These highlighting schemes are sometimes represented by bold borders in the drawings.

Once content has been selected (and, if desired, highlighted), the content may be manipulated by software such as an application or operating system on computing equipment 12. For example, selected content may be moved, may be deleted, may be copied, may be attached to an email or other message, may be inserted into a document or other file, may be compressed, may be archived, or may be otherwise manipulated using equipment 12.

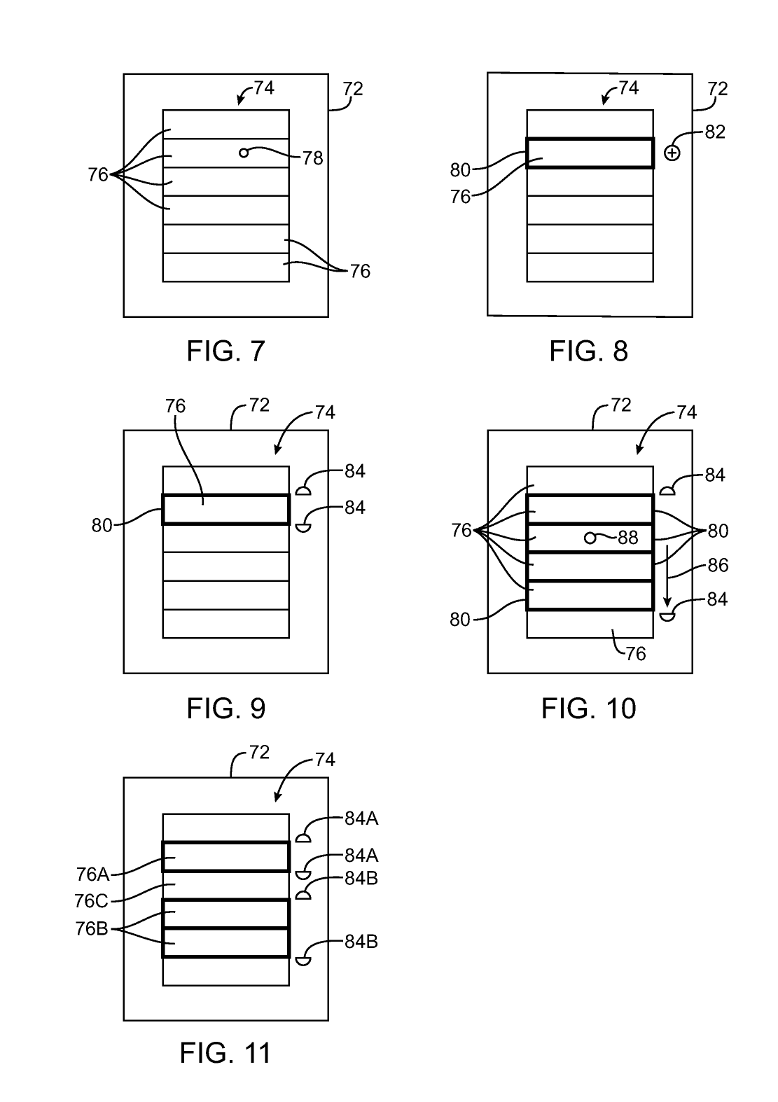

FIG. 7 shows a screen that contains selectable data items. Screen 72 of FIG. 7 (and the other FIGS.) may be displayed on a display such as a touch screen display 30 of FIG. 2). As shown in FIG. 7, data items 76 may be organized in a list such as list 74 (e.g., a one-dimensional list). There may be one, two, three, four, or more than four data items in a list. If a list contains more than one screen of data items, the list may be scrolled. Data items 76 may be non-interactive content such as non-clickable text or may represent launchable files. For example, data items 76 may be clickable files that are represented by clickable filenames, clickable file icons, or clickable thumbnails. In this type of arrangement, a double click (double tap) may be used to direct computing equipment 12 to automatically launch an associated application for processing the data items. If, as an example, a user double clicks (double taps) on an image thumbnail, computing equipment 12 may launch an application or operating system function that handles image file viewing operations and may open the image file that is associated with the image thumbnail.

A user may select a desired data item using a touch contact gesture (e.g., a tap or a hold) such as touch gesture 78. As shown in FIG. 8, the selected data item (i.e., selected data item 76) may be highlighted using highlight region 80. In response to detecting the touch contact gesture (or mouse click or other input command) from the user that selects the desired data item in list 74, computing equipment 12 may display a selectable on-screen option such as option 82. Option 82 may be displayed on screen 72 at a location that is adjacent to selected data item 76. Option 82 may be presented as a symbol, as text, as an image, as an animation or other moving content, using other visual representation schemes, or using a combination of such schemes.

A user may select option 82 by touching option 82 with a finger (i.e., using a touch contact gesture such as a tap gesture or hold gesture on top of the displayed option) or using other user input. As shown in FIG. 9, computing equipment 12 may display markers 84 in response to the user's selection of option 82. Markers may, for example, be displayed immediately before and after (e.g., above and below) the selected data item in list 74, so that there are no intervening unselected data items between the markers and the selected data item. Markers 84, which may sometimes be referred to as handles, selectors, indicators, selection range indicators, etc. may be square, semicircular, triangular, or line-shaped, or may have other suitable shapes.

Markers 84 may be moved using drag touch gestures (and, if desired, click and drag commands). FIG. 10 shows how a user may move the lower of the two displayed markers 84 using drag command 86. As the markers 84 are moved in this way, computing equipment 12 may update list 74, so that all data items that are located between markers 84 are highlighted (as shown by highlighting 80 in the example of FIG. 10).

If a user contacts (touches) one of the selected and highlighted data items as indicated by touch contact 88 of FIG. 10, the selected data item that is touched may be deselected as shown in FIG. 11. As shown in FIG. 11, touching one of the selected data items in the middle of a data item list breaks the list into two regions of selected data items. In the FIG. 11 example, computing equipment 12 responded to touch contact 88 of FIG. 10 by splitting list 74 into upper selected data item range 76A and lower selected data item range 76B. These ranges are separated by deselected (and unhighlighted) data item 76C. Markers 84 of FIG. 10 may be replaced with markers 84A (to indicate the starting and ending boundaries of selected data item range 76A) and makers 84B (to indicate the starting and ending boundaries of selected data item range 76B). Ranges 76A and 76B can be modified by dragging markers 84A and 84B. For example, these ranges can be merged if upper marker 84B is dragged up to lower marker 84A or if lower maker 84A is dragged down to the position occupied by the uppermost one of markers 84B. If desired, a user may deselect multiple intermediate data items from a list of data items. In response, computing equipment 12 may create three or more individual ranges of selected data items, depending on the number of intervening data items that are deselected. Each respective range may be provided with a pair of corresponding markers that may be moved to merge some or all of the ranges of selected data items.

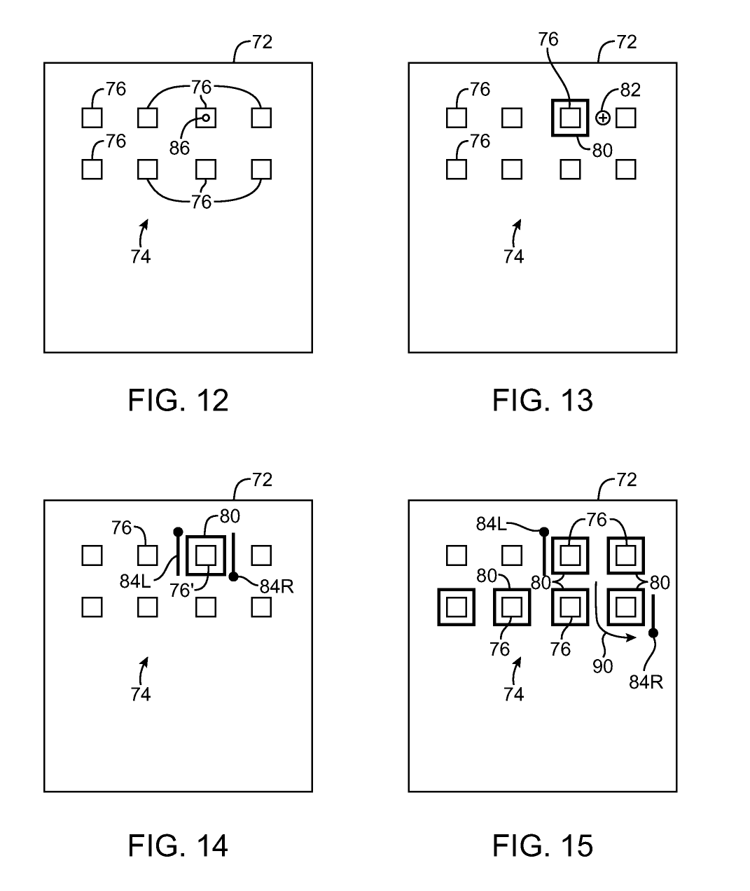

As shown in FIG. 12, list 74 may include data items 76 that are arranged in a two-dimensional array. The array may include multiple rows and multiple columns of data items such as image thumbnails, other file thumbnails, file names, icons, etc. These items may be files (e.g., clickable files represented by icons, filenames, or thumbnails that are launchable with a double click or double tap, etc.). A user may select a desired data item using touch contact gesture 86 (e.g., a tap or a hold gesture). In response to detection of touch contact 86, computing equipment 12 may highlight the data item that was selected, as indicated by highlight 80 for selected data item 76 in FIG. 13. As shown in FIG. 13, computing equipment 12 may also display a user-selectable option such as option 82. Option 82 may be presented as an icon, as text, as an image, or using any other suitable visual format. Option 82 may be selectable (e.g., by clicking or using a touch gesture such as a touch contact). Option 82 may be displayed adjacent to highlighted data item 76 or elsewhere on screen 72.

In response to detection of a user touch contact on option 82 or other user command to select option 82, computing equipment 12 may present movable markers such as markers 84L and 84R. Markers 84L and 84R may have the shape of lollipops (as an example) and may therefore sometimes be referred to as lollipops or lollipop-shaped markers. Markers 84L and 84R may, if desired, have unique shapes or layouts. For example, marker 84L may have an upright lollipop shape and marker 84R may have an inverted lollipop shape. Markers 84L and 84R may, respectively, denote the beginning and ending boundaries of the selected data items in list 74. In a typical arrangement, for example, marker 84L marks the start location in list 74 at which data items 76 have been selected and highlighted using highlight 80. Marker 84R may mark the end location of the selected data item region.

All data items that are located between markers 84L and 84R in list 74 are selected and highlighted. In a single-dimensional horizontal array, data items may be considered to lie between markers 84L and 84R if the data items are located to the right of marker 84L and to the left of marker 84R. In a two-dimensional array, data items may be ordered using a left-to-right and top-to-bottom row ordering scheme, so data items in a two-dimensional array are considered to lie between marker 84L and marker 84R whenever this ordering scheme indicates that a given data item is to the right of marker 84L or is located in a subsequent row and lies to the left of marker 84R (or is located in an intervening row).

As with markers 84 of FIGS. 9-11, markers 84L and 84R of FIG. 14 may be moved by a user. A user may move markers 84L and 84R using user input such as touch commands. In the illustrative arrangement of FIG. 15, a user has used drag touch command 90 to move marker 84R to a position at the end of the second row of data items in list 74. As a result, all intervening data items 76 in list 74 have been selected and highlighted by computing equipment 12, as indicated by the presence of highlight regions 80 between markers 84L and 84R in FIG. 15.

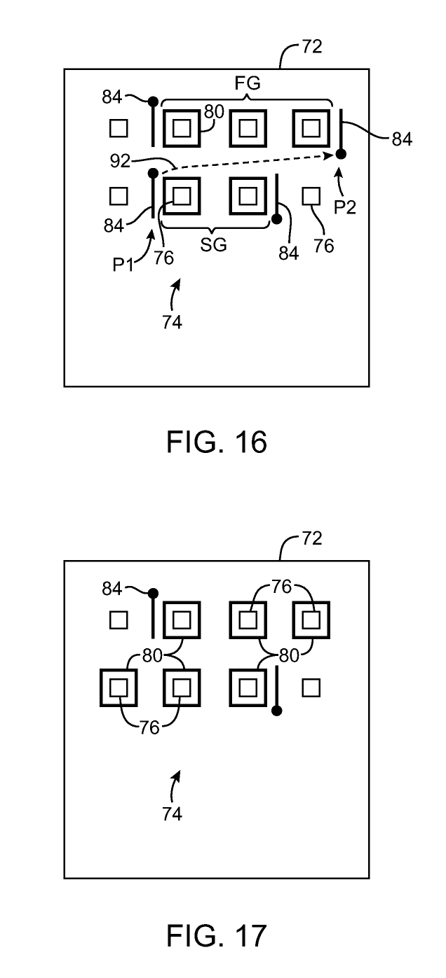

A user may deselect a selected data item using a command such as a touch contact on the item that is to be deselected. A user who is presented with list 74 of FIG. 15 may, for example, touch the leftmost selected data item in the second row of list 74. In response, computing equipment 14 may deselect this data item and remove the highlight from the deselected item (see, e.g., FIG. 16). Deselecting a data item that lies in an interior portion of the group of selected data items breaks selected data items 76 into multiple individual groups (ranges) of selected data items, as indicated by first group FG and second group SG of selected data items 76 in list 74 of FIG. 16. FIG. 16 also shows how computing equipment 12 may provide additional markers 84 on screen 72, so that each group of selected data items in list 74 is bounded at its beginning and end with a pair of respective makers 84.

A user may merge distinct groups of selected data items by dragging markers 84. For example, a user may drag the marker at position P1 in list 74 to position P2 using drag gesture 92. In response, computing equipment 12 may merge groups FG and SG to create a single uninterrupted group of selected data items between a single pair of corresponding markers 84, as shown in FIG. 17.

Data items that have been selected and highlighted using arrangements of the type described in connection with FIGS. 7-17 may be manipulated using computing equipment 12. For example, computing equipment 12 may receive user input such as a touch gesture, keyboard command, or other instruction that directs computing equipment 12 to perform a particular operation on the selected data items or to take other appropriate actions. As an example, a user may direct computing equipment 12 to delete the selected items (e.g., by pressing a delete key), to move the selected items (e.g., using a drag-and-drop touch gesture or mouse command), to copy the selected items, to compress the selected items, to cut the selected items for subsequent pasting, to rename the selected items, etc.

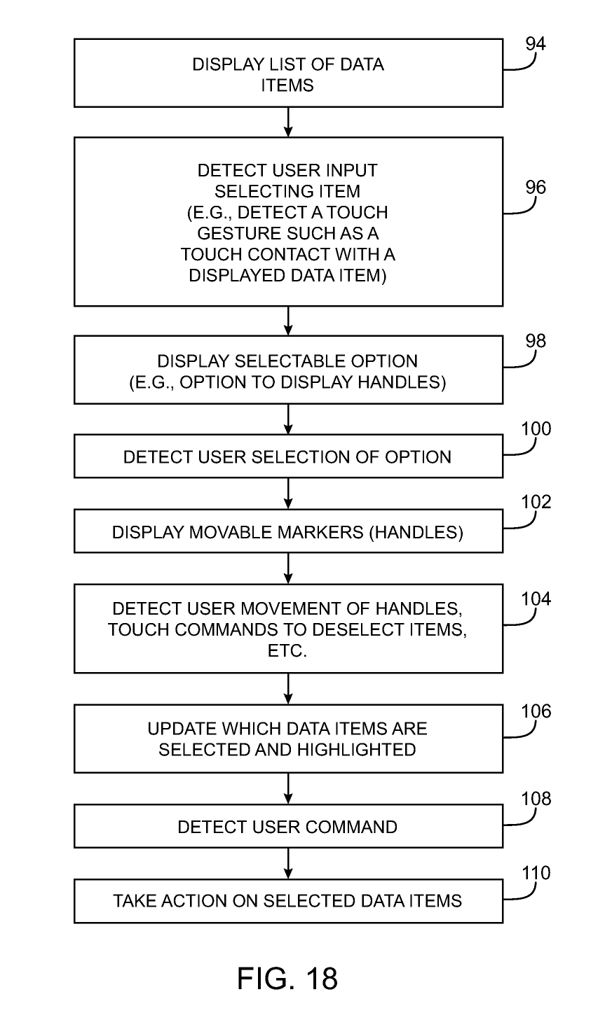

Illustrative steps involved in selecting and highlighting data items in list 74 and in taking appropriate actions on the selected data items are shown in FIG. 18. At step 94, the data items may be displayed in a list such as list 74. Computing equipment 12 may, for example, display list 74 in a screen such as screen 72 that is associated with a touch screen display (e.g., touch screen display 30 of FIG. 2). List 74 may be a one-dimensional list (e.g., a table having only one row or only one column) or may be a two-dimensional list (e.g., an array with multiple rows and columns). The displayed data items may be clickable data items (e.g., files represented by clickable icons, clickable file names, clickable thumbnails, etc.).

A user may use a touch gesture or other user input to select a given one of data items 76 in list 74. The user may, for example, make contact (i.e., a tap gesture or a hold gesture) with the given data item on the touch screen. At step 96, computing equipment 12 may detect the touch contact with the given data item or other user input. In response, computing equipment 12 may select and highlight the given data item and may display selectable option 82 (step 98).

A user may select option 82 to instruct computing equipment 12 to display movable markers 84. For example, the user may select option 82 with a touch contact gesture (e.g., a tap or a hold gesture on top of option 82). At step 100, computing equipment 12 may detect that the user has touched option 82 or has otherwise selected option 82. In response, computing equipment 12 may display movable markers 84 immediately before and after the selected data item, as shown in FIGS. 8 and 13 (step 102).

The user may move makers 84 using user input such as drag gestures. The user may also touch selected data items to deselect these items (e.g., using a touch contact on the items that are to be deselected). At step 104, computing equipment 12 may detect the user commands such as the drag and touch contact gestures. In response, computing equipment 12 may, at step 106, update list 74 (e.g., to reflect new marker positions and new data items selections in response to drag commands that move markers, to reflect the deselection of data items that were previously selected in response to touch contacts, etc.).

If a user desires to select additional items, to deselect previously selected items, or to move markers to make selections and deselections, the user may repeatedly supply computing equipment 12 with additional user input such as gestures and some or all of operations of steps 96, 98, 100, 102, 104, and 106 may be repeated. When a user has selected all desired data items, the use may perform a desired action on the selected data items. For example, the user may enter a keyboard command by pressing one or more keys (e.g., by pressing a delete key). The user may also enter commands using a mouse, track pad, or other pointing device (e.g., to form a drag and drop command). Touch gestures such as drag gestures and user input that involves the selection of one or more on-screen options may also be used to supply user input.

At step 108, computing equipment 12 may detect the user input that has been supplied. In response, computing equipment 12 may take appropriate actions (step 110). For example, computing equipment 12 may run an application or operating system function that moves the selected data items within list 74, that moves the selected items from list 74 to another location, that deletes the selected data items, that compresses the selected data items, that renames the selected data items, or that performs other suitable processing operations on the selected data items.

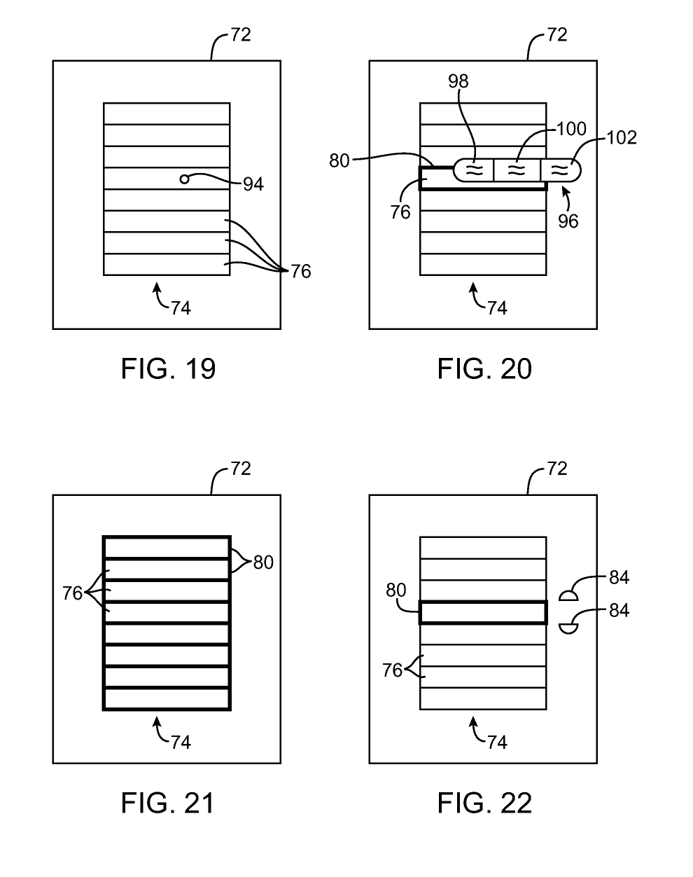

If desired, on-screen menu items that are somewhat more complex than illustrative options 82 of FIGS. 8 and 13 may be displayed to assist a user in selecting desired data items. This type of arrangement is illustrated in connection with the example of FIGS. 19-22.

As shown in FIG. 19, computing equipment 12 may display a data item list on screen 72, such as list 74 of data items 76 (e.g., clickable and launchable data items such as clickable files represented by clickable filenames, clickable thumbnails, clickable icons, etc.). A user may use a command such as touch contact gesture 94 to select one of the displayed data items. In response, computing equipment 12 may highlight the selected data item, as shown by highlight 80 on data item 76 in list 74 of FIG. 20. A region that contains multiple on-screen options such as options region 96 may also be displayed. Region 96 may be displayed adjacent to the selected item, in a location that partly or fully overlaps with the selected data item, or at other suitable locations. Region 96 may be continuous or discontinuous (e.g., to display multiple options in different locations on screen 72).

There may be one, two, three, or more than three options in region 96. In the example of FIG. 20, options region 96 contains three options. Some or all of the options may relate to selection-type operations (i.e., these options may be selection options). Option 98 may, for example, be a “select all” option. When a user touches or otherwise selects option 98, computing equipment 12 may select and highlight all data items 76 in list 74, as shown in FIG. 21. Option 100 may be a “select more” option. In response to detection of a user touch on option 100, computing equipment 12 may display movable markers 84 before and after the selected data item, as shown in FIG. 22. Option 102 may be an “unselect all” option. When a user touches or otherwise selects option 102, computing equipment 12 may respond by removing all highlights 80 from the data items of list 74 (see, e.g., FIG. 19).

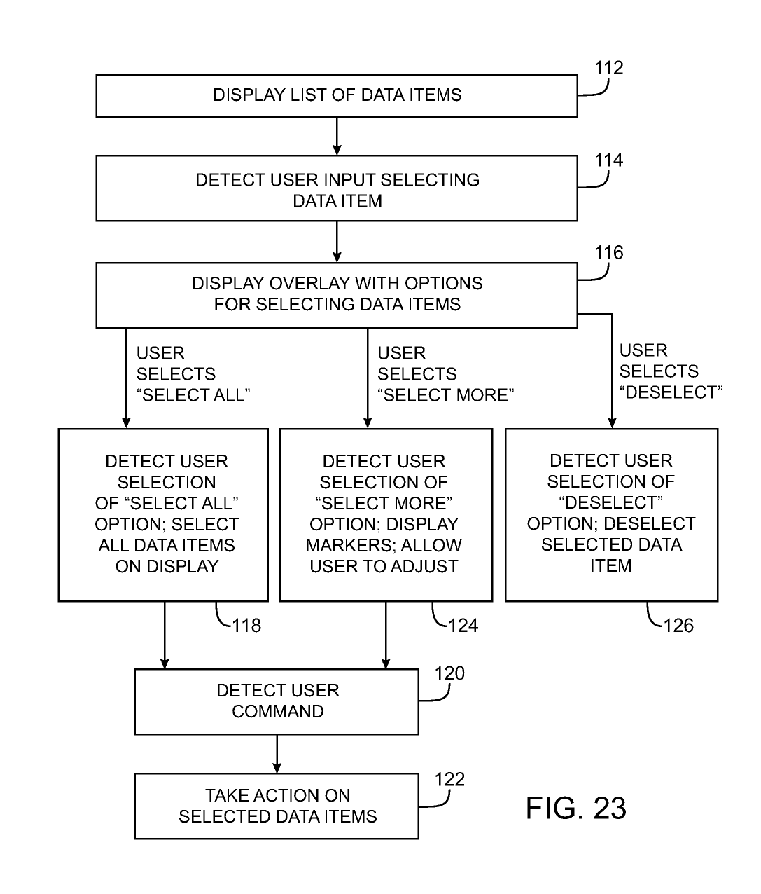

Illustrative steps involved in supporting user selection and manipulation of data items using an arrangement of the type shown in FIGS. 19-22 are shown in FIG. 23. At step 112, computing equipment 12 may display list 74 of data items 76 on screen 72.

A user may select one of data items 76 using user input such as a touch contact gesture. At step 114, computing equipment 12 may detect the touch gesture selecting a given data item.

At step 116, in response to detection of the user gesture, computing equipment 12 may select the desired item (highlight 80 of FIG. 20) and may display region 96. Region 96 may contain one or more selectable options, each of which may be individually labeled (e.g., with custom text, custom graphics, etc.). Each option may offer the user an opportunity to perform a different type of data item selection operation. A user may select a desired option by touching the option with a finger or other external object.

If computing equipment 12 detects that the user has selected an “unselect all” option, computing equipment 12 may deselect all items 76 (step 126). If desired, region 96 may have an unselect option for deselecting individual data items (e.g., as an alternative to an “unselect all” option or as an additional option). Once all items have been deselected, processing can return to step 112 to allow the user to select desired items.

In response to detection of user selection of a “select more” option, computing equipment 12 may display markers 84 and may allow the user to use drag commands or other user input to adjust the position of the markers and thereby adjust which data items in list 74 are selected (step 124).

If computing equipment 12 detects that the user has selected the “select all” option, computing equipment 12 may select and highlight all data items in list 74 (step 118).

After desired items have been selected, a user may use a touch gesture or other user command to direct computing equipment 12 to take a desired action on the selected data items. In response to detecting the user input at step 120, computing equipment 12 may take the desired action at step 122 (e.g., by deleting the selected items, moving the selected items, copying the selected items, cutting the selected items, renaming the selected items, sorting the selected items, etc.).

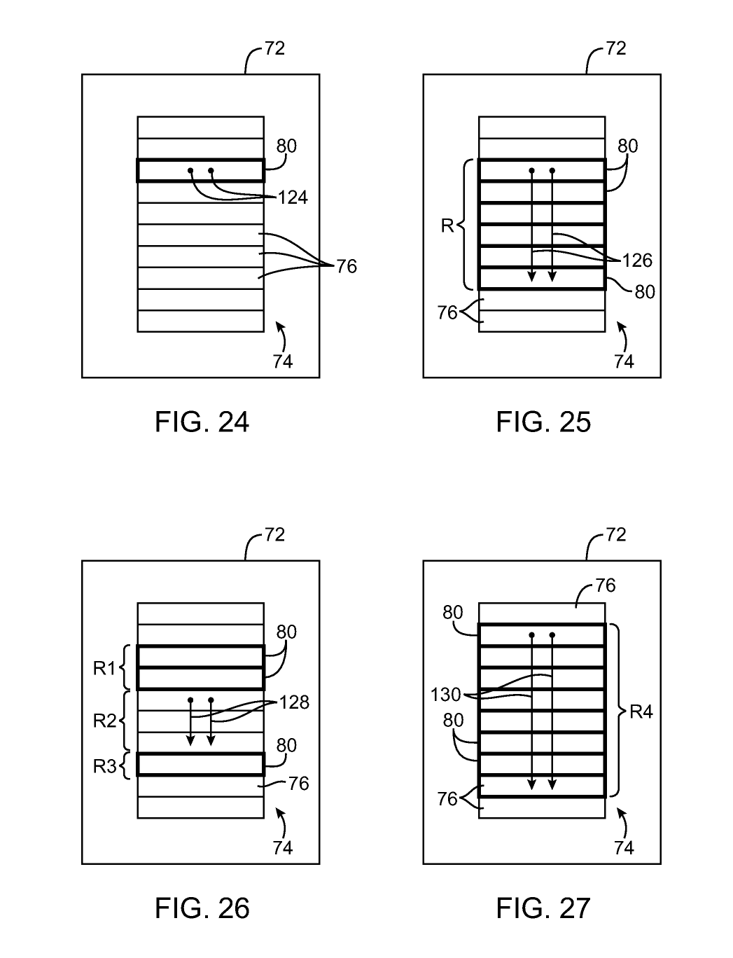

Gestures such as multifinger swipes may be used in selecting data items 76. An illustrative example is shown in FIG. 24-27.

As shown in FIG. 24, computing equipment 12 may display data items 76 (e.g., clickable files) in list 74 on screen 72. A user may use a multifinger gesture such as a two-finger tap or hold (gesture 124) to select and highlight a desired one of data items 76. Highlight 80 may be used to highlight the selected data item.

The user may perform a swipe such as two-finger swipe 126 of FIG. 25 to select multiple data items (e.g., to select range R of data items 76).

Items that have been selected and highlighted can be deselected. For example, a user may use swipe gesture 128 of FIG. 26 to deselect the data items in range R2 of list 74, thereby breaking range R into sub-ranges R1 and R2 of selected items 76.

FIG. 27 shows how computing equipment 12 may respond to detection of a swipe gesture such as a two-finger swipe gesture that passes over the selected items of range R1 and range R2 and the deselected (unselected) items of range R2. As shown in FIG. 27, when two-finger swipe gesture 130 is detected, computing equipment 12 may select and highlight all data items that are covered by the swipe, thereby forming a unified group (range R4) of selected data items 76, each of which is highlighted with a respective highlight 80.

Swipe gestures such as gestures 126, 128, and 130 may be performed directly on data items 76 or may be performed adjacent to data items 76 (i.e., at a location that is horizontally offset from data items 76 when data items 76 are oriented in a vertical one-dimensional list as in the example of FIGS. 24-27). The swipe gestures may be one-finger gestures, two-finger gestures, or may use three or more fingers.

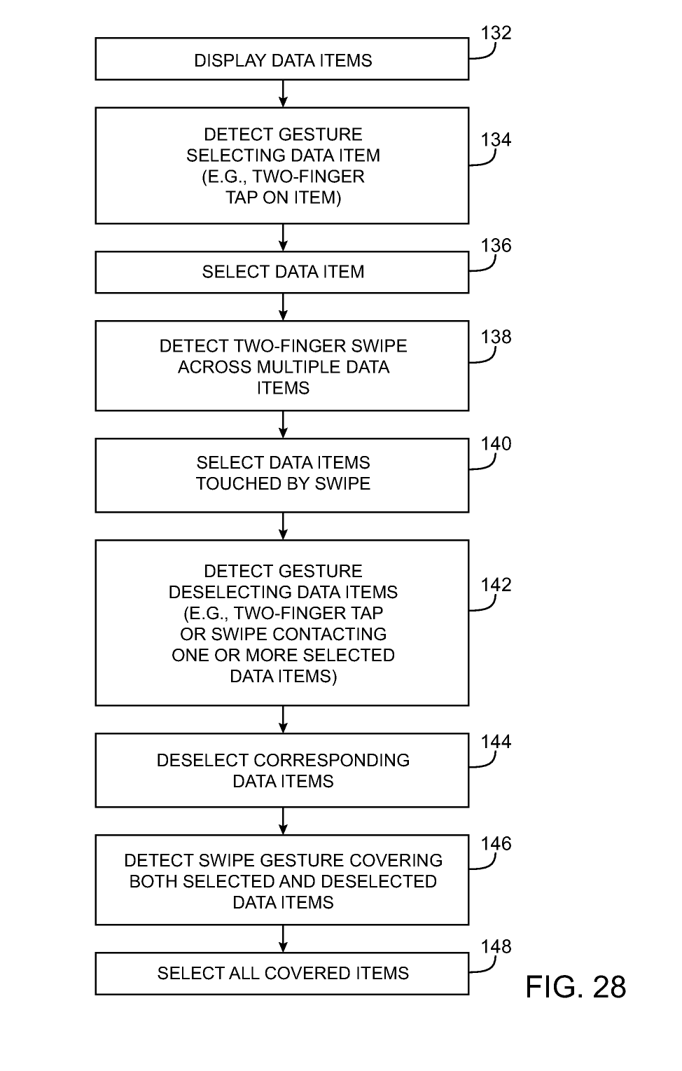

Illustrative steps in using gestures such as the two-finger touch gestures of FIGS. 24-27 to select data items are shown in FIG. 28.

At step 132, computing equipment 12 may display data items 76 in list 74 on screen 72. Data items 76 may be files (e.g., clickable files such as files represented by clickable icons, clickable filenames, clickable thumbnails, etc.).

A user may select a desired one of the displayed data items using a touch command. For example, the user may use a two-finger touch contact (e.g., a two-finger tap or two-finger hold) to select a data item, as shown in FIG. 24.

In response to detection of a two-finger touch contact with a data item, computing equipment 12 may select and highlight the data item at step 136 (see, e.g., highlight 80 of FIG. 24).

A user may use a two-finger swipe to select multiple data items in a list. The swipe may pass directly over each data item of interest or may pass by the data items at a location that is offset from the data items.

In response to detection of a two-finger swipe or other gesture that covers (i.e., runs over or alongside) data items of interest (step 138), computing equipment 12 may select and highlight the corresponding data items in list 74 (step 140).

A user may also use swipes and double-finger touches (e.g., taps) to deselect items, as described in connection with FIG. 26.

In response to detection of a swipe that corresponds to previously selected data items (step 142), computing equipment 12 may deselect and remove the highlight from the data items (step 144).

As described in connection with FIG. 27, a user may use a swipe gesture to reselect deselected data items and may join ranges of selected data items by selecting at least all of the deselected items that lie between respective ranges of selected items.

In response to detection of a two-finger swipe or other gesture that covers both selected and unselected data items (step 146), computing equipment 12 may leave the selected data items in their selected state while selecting all of the affected deselected items. In situations such as the scenario described in connection with FIG. 27 in which the swipe covers the entirety of the deselected range between two respective ranges of selected items, the ranges may be merged to form a single set of selected items. Two, three, or more than three discrete sets of selected data items in a list may be merged in this way.

The foregoing is merely illustrative of the principles of this invention and various modifications can be made by those skilled in the art without departing from the scope and spirit of the invention. The foregoing embodiments may be implemented individually or in any combination.

What is claimed is:

1. A method, comprising:
with computing equipment having a touch screen display, displaying a list of data items on the display;
with the computing equipment, detecting a two-finger swipe gesture made on the touch screen display that is associated with a group of the data items; and
in response to detection of the two-finger swipe gesture, selecting the group of data items.

2. The method defined in claim 1 wherein the list of data items is a one-dimensional list and wherein detecting the two-finger swipe gesture comprises detecting a two-finger swipe gesture that passes over each of the data items in the group of data items.

3. The method defined in claim 2 further comprising deselecting at least a portion of the selected data items using a two-finger swipe gesture that that passes over the portion of the selected data items.

4. The method defined in claim 3 wherein at least two separate ranges of selected data items are displayed in the list after deselecting the portion of the selected data items, the method further comprising:
merging the separate ranges into a single range of selected data items in response to detection of a two-finger swipe gesture.

5. The method defined in claim 4 wherein selecting the group of data items comprises highlighting each of the data items in the group and wherein the data items are files selected from the group consisting of: files represented by filenames, files represented by icons, and files represented by thumbnails.

6. The method defined in claim 5 wherein selecting the group of data items comprises selecting files using an operating system on the computing equipment that is responsive to the two-finger swipe gesture.

7. The method defined in claim 4 wherein selecting the group of data items comprises selecting a group of images and highlighting the selected images.

8. The method defined in claim 4 wherein selecting the group of data items comprises selecting and highlighting table entries in a table.

9. The method defined in claim 4 further comprising:
with the computing equipment, detecting a command from a user; and
in response to detecting the command, taking action on the group of selected data items without taking action on data items in the list that are not contained in the group.

10. A method, comprising:
with computing equipment having a touch screen display, displaying a two-dimensional list of files on the display;
with the computing equipment, displaying markers on the touch screen display at respective ends of a group of one or more selected files in the list of files; and
in response to detection of drag commands on the touch screen display, moving the markers to adjust which files in the list are in the group of selected files.

11. The method defined in claim 10 wherein displaying the markers comprises displaying lollipop-shaped markers on the display.

12. The method defined in claim 10 further comprising highlighting each of the selected files in the group of files, wherein the selected files in the group of files comprise files selected from the group consisting of: files represented by filenames, files represented by icons, and files represented by thumbnails.

13. The method defined in claim 10 wherein the two-dimensional list of files has rows and columns, the method further comprising:
detecting a drag touch gesture on the touch screen display that moves at least one of the markers between respective rows in the list of files.

14. The method defined in claim 10 further comprising:
detecting a touch command on at least a given one of the selected files in the group of selected files; and
in response to detecting the touch command on the given one of the selected files, breaking the group of selected files into two separate groups.

15. The method defined in claim 14 further comprising:
merging the two separate groups of selected files in response to detection of a drag touch gesture that moves one of the markers on the touch screen display.

16. A method, comprising:
with computing equipment having a touch screen display, displaying files in a list;
with the computing equipment, detecting a touch contact gesture on a given one of the displayed files on the touch screen display;
in response to detecting the touch contact gesture on the touch screen display, highlighting the given one of the displayed files and displaying at least one selectable option on the touch screen display adjacent to the given one of the displayed files; and
in response to detection of a touch gesture selecting the at least one selectable option on the touch screen display, displaying movable markers adjacent to the highlighted data item.

17. The method defined in claim 16 further comprising:
in response to detection of a drag touch gesture on one of the movable markers, moving that movable marker and highlighting additional displayed files in the list.

18. The method defined in claim 17 wherein displaying the selectable option comprises displaying a selectable symbol on the touch screen display.

19. The method defined in claim 18 wherein displaying the files comprises displaying a two-dimensional list of clickable file icons.

20. A method, comprising:
with computing equipment having a touch screen display, displaying files in a list;
with the computing equipment, detecting a touch contact gesture on a given one of the displayed files on the touch screen display;
in response to detecting the touch contact gesture on the touch screen display, highlighting the given one of the displayed files and displaying a selectable option region that contains a plurality of selectable options adjacent to the given one of the displayed files; and
in response to detection of a touch gesture selecting a given one of the selectable options on the touch screen display, adjusting which of the displayed files in the list are highlighted.

21. The method defined in claim 20, wherein the plurality of selectable options includes a select all option and wherein adjusting which of the displayed files in the list are highlighted comprises highlighting all of the displayed files in response to detection of a touch gesture on the touch screen display to select the select all option.

22. The method defined in claim 21, wherein the plurality of selectable options includes a select more option and wherein adjusting which of the displayed files in the list are highlighted comprises displaying movable markers on the touch screen display in response to selection of the select more option and moving at least one of the moveable makers in response to a drag touch gesture to adjust which of the displayed files are between the markers.

23. The method defined in claim 22, wherein the plurality of selectable options includes a deselect all option and wherein adjusting which of the displayed files in the list are highlighted comprises removing highlighting from all of the highlighted displayed files in response to detection of a touch gesture on the touch screen display to select the deselect all option.
